(19) United States
(12) Patent Application Publication
(10) Pub. No.: US 2014/0131600 A1
(43) Pub. Date: May 15, 2014

(54) DISCHARGE VALVE FEATHER CONTROL

(71) Applicant: ROM ACQUISITION CORPORATION, BELTON, MO (US)

(72) Inventor: John E. McLoughlin, Hauppauge, NY (US)

(73) Assignee: ROM ACQUISITION CORPORATION, BELTON, MO (US)

(21) Appl. No.: 14/030,049

(22) Filed: Sep. 18, 2013

Related U.S. Application Data
(60) Provisional application No. 61/726,659, filed on Nov. 15, 2012.

(51) Int. Cl. A62C 37/36; A62C 27/00

(52) U.S. Cl. CPC A62C 37/04; A62C 27/00
USPC 251/129.01

(57) ABSTRACT

A control system for driving a motor that operates a valve comprises an open control switch operable to generate a first input signal in response to manual activation, a close control switch operable to generate a second input signal in response to manual activation, and a feather control switch operable to generate a third input signal in response to manual activation. The system further comprises a microcontroller operable to generate a feathered control signal in response to receiving a third signal and one of a first and second input signals substantially simultaneously, the feathered control signal operable to cause the drive motor to change the setting of the discharge valve at a feathered speed.

### RELATED APPLICATION

The present application claims the benefit of Provisional Patent Application No. 61/726,659 filed on Nov. 15, 2012.

### FIELD

The present disclosure generally relates to a discharge valve feather control for a firefighting vehicle.

### BACKGROUND

Firefighting is a highly dangerous occupation that subjects firefighters to many hazards. It is critically important that firefighters have the right amount of water flow (gallons per minute or gpm) when they are combating a fire in various conditions and environments. Determining the water flow rate in a fire hose is an important task for firefighters responsible for operating fire apparatus pumps. Delivering water at the proper flow rate and pressure to firefighters controlling the fire hose nozzles is vital to ensure safe operations. Pressures and flow rates too low will be insufficient for fire control, while pressures and flow rates that are too high creates dangerous conditions with handling the nozzle, burst hose, and other hazards.

Presently there are electric devices for controlling opening and closing discharge valves on a firefighting vehicle, such as a tanker or pumper fire engine. These electric control devices operate at set speeds to open or close the valve. When a firefighter desires to make small adjustments of the discharge valve to change the flow rate from 100 gpm to 105 or 110 gpm, for example, it is very easy to overshoot the desired setting, and multiple manipulations of the controls are often required to reach the desired flow rate.

### BRIEF DESCRIPTION OF THE DRAWINGS

FIG. 1 is a simplified block diagram of an exemplary embodiment of an automatic valve feather control system according to the present disclosure; and

FIG. 2 is a simplified flowchart of an exemplary embodiment of an automatic valve feather control method according to the present disclosure.

### DETAILED DESCRIPTION

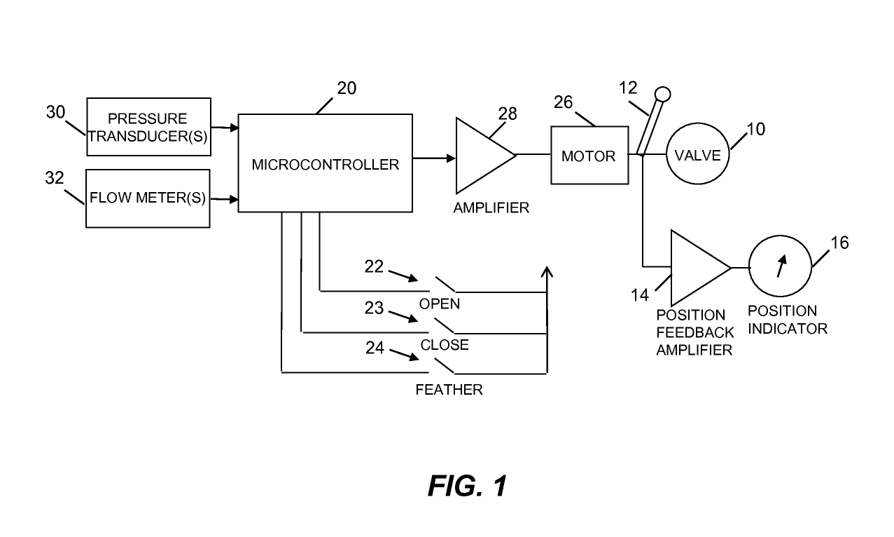

FIG. 1 is a simplified block diagram of an exemplary embodiment of an automatic valve feather control system according to the present disclosure. The depicted system is installed on a firefighting vehicle (not shown), such as a pumper or tanker fire engine that carries water in a tank or obtains water from an outside source, such as a fire hydrant, drop tank, swimming pool, or lake. The pumper vehicle includes a discharge valve 10 that is used to control water or other liquids being released through a pipe or hose. A manual lever or handle 12 may be used to manually change the setting of the discharge valve 10. The setting of the discharge valve 10 or manual handle 12 is provided by a position feedback amplifier 14 and displayed by a position indicator 16.

The automatic valve feather control system includes a microprocessor or microcontroller 20 that receives the activation signals of three valve control switches 22-24. Control switch 22 and control switch 23 are operable to instruct a drive motor 26 to open and close the discharge valve 10, respectively. These control switches 22 and 23 are preferably disposed on a pump panel equipped with many levers, switches, and gauges, including the position indicator 16 of the discharge valve 10. The pump panel is typically a collection of levers and switches that controls how much water is flowing and which lines are being discharged from the pumper/tanker. Typically, activating the open control switch 22 causes the discharge valve 10 to open, and activating the close control switch 23 causes the discharge valve 10 to close. The amount of time the control switches 22 and 23 are activated (pressed) determines the extent the valve is opened or closed.

A third control switch 24, is provided as a feather control switch. When activated, the control switch 24 sends a feather control signal to the microprocessor or microcontroller 20. As a result, the microcontroller 20 generates a signal that is operable to slow down the drive motor (electric, pneumatic, or hydraulic) 26 to the discharge valve 10. Accordingly, when the feather control switch 24 is activated (e.g., pressed) substantially at the same time or while the open control switch 22 or the close control switch 23 is activated, the microcontroller 20 instructs the drive motor 26 to operate at a slower predetermined rate, which enables smaller or finer adjustments to the setting of the discharge valve 10 to be made. When the feather control switch 24 is deactivated or not pressed while the open or close control switch 22 or 23 is not activated, the drive motor 26 runs or operates at the normal predetermined speed. As shown in FIG. 1, an amplifier 28 may be used to amplify the drive motor control signal from the microcontroller 20.

Accordingly, activating the feather control switch 24 enables smaller incremental changes to be made in the setting of the discharge valve 10, so that the desired discharge setting can be achieved more easily.

In a second embodiment, activation of the feather control switch 24 is operable to slow down the drive motor speed for a predetermined period of time, when the open or close control switch 22 or 23 is also activated. As a result, the activation of the open or close control switch 22 or 23 during this time period is affected by the feather control signal, resulting in a slower drive motor speed and finer changes to the discharge valve setting. After the predetermined period of time has lapsed, the drive motor speed automatically resumes to the normal speed. This predetermined period of time can be from ½ second to 3 seconds, for example. The predetermined time period of activation for feathered control may also be programmable and/or modifiable on-the-fly according to the pump operator's preference, for example. In operation, the feather control switch 24 does not need to be continually activated (pressed) while the open or close control switches 22 or 23 is activated, which may simplify operations.

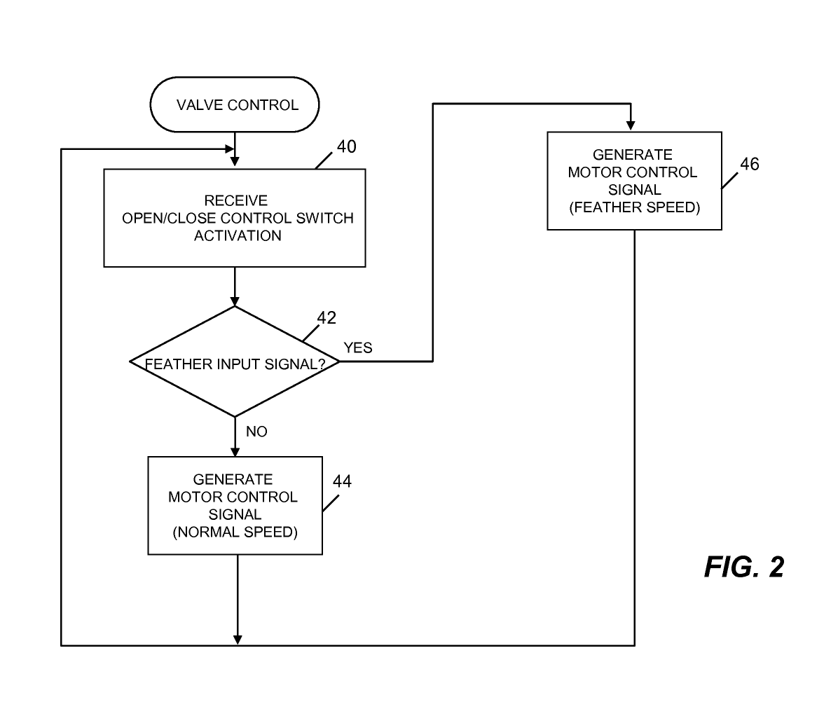

FIG. 2 is a simplified flowchart of an exemplary embodiment of an automatic valve feather control method according to the present disclosure. In block 40, the microcontroller 20 receives control signals from the open or close switch 22 or 23. The microcontroller 20 determines whether the feather input control switch 24 is also activated in block 42. As described above, the feather control switch 24 may be activated substantially simultaneously as the open or close control switches 22 or 23, or the feather control switch 24 may be activated to initiate a predetermined or programmable feather control time period, in which activating the open and close control switches 22 and 23 is implemented with a slower drive motor speed. If the feather control input signal is not in effect (not activated), then the microcontroller 20 generates a motor control signal that instructs the drive motor to operate at a normal speed to open or close the discharge valve. If, on the other hand, the feather control input signal is in effect (activated), then the microcontroller generates a motor control signal that instructs the drive motor to operate at a feather speed to open or close the discharge valve at a slower rate. The method loops back to block 40 for processing further activations of the control switches.

In further embodiments, the microcontroller 20 further receives sensor inputs from one or more pressure transducers 30 and flow rate meters 32 disposed inline of the fluid flow, such as upstream of the discharge valve 10. The microcontroller 20 may make calculations that take these input data into account and modulate the control signals in response to these sensor data inputs.

Accordingly, by using the feather control switch 24 the operation of the discharge valve 10 can be more refined to make smaller and more precise adjustments to the setting of the discharge valve 10 when needed.

The drive motor speed can be varied by a number of ways dependent on the type of motor that is used to operate the discharge valve. For an electric motor, pulse width modulation or voltage control techniques may be used. For a pneumatic (air) motor, pressure or flow regulation techniques may be used. For a hydraulic motor, flow regulation techniques may be used. Accordingly, the microcontroller 20 is adapted to generate suitable controls signals to modify the drive motor speed according to the input of the controls switches 22-24.

It should be noted that the word “water” is used herein to generally convey the concept of a fluid used for firefighting purposes, and “water” may include water, foam, chemicals, and other types of fire-suppression fluids.

Further notice should be given regarding the actual implementation of the system in that certain changes and modifications to the described system, though not described explicitly or in detail, are contemplated herein. For example, the microcontroller may be implemented using one or more CPU, or micro-controller circuits. Further, it is understood that a CPU is typically in operation with its attendant circuitry and software, such as memory, interfaces, drivers, etc. as known in the art. Additionally, although not shown explicitly, the system includes memory that may be implemented using one or more data storage devices of a variety of types now known or later developed. Similarly, the system may employ wireless communication that may be achieved using any technology and protocol suitable for the firefighting application. Although wireless communication is the general way information may be conveyed, the communication between the microcontroller and any controlled component and sensor may be achieved by wired and/or wireless means.

The features of the present invention which are believed to be novel are set forth below with particularity in the appended claims. However, modifications, variations, and changes to the exemplary embodiments described above will be apparent to those skilled in the art, and automatic fire pump control system and method described herein thus encompasses such modifications, variations, and changes and are not limited to the specific embodiments described herein.

What is claimed is:

1. A control system for controlling a drive motor operating a discharge valve on a firefighting vehicle, comprising:
an open control switch operable to generate a first input signal in response to manual activation;
a close control switch operable to generate a second input signal in response to manual activation;
a feather control switch operable to generate a third input signal in response to manual activation;
a microcontroller operable to receive the first input signal and generate a first control signal in response to the received first signal, the first control signal operable to cause the drive motor to change the setting of the discharge valve at a normal speed, the microcontroller further operable to receive the second input signal and generate a second control signal in response to the received second signal, the second control signal operable cause the drive motor to change the setting of the discharge valve at a normal speed;
the microcontroller further operable to receive the first and third input signals and generate a third control signal in response to the received first and third signals, the third control signal operable to cause the drive motor to change the setting of the discharge valve at a feather speed slower than the normal speed; and
the microcontroller further operable to receive the second and third input signals and generate a fourth control signal in response to the received second and third signals, the fourth control signal operable to cause the drive motor to change the setting of the discharge valve at a feather speed slower than the normal speed.

2. The control system of claim 1, wherein the microcontroller is operable to generate the third control signal in response to receiving the first and third input signals substantially simultaneously.

3. The control system of claim 1, wherein the microcontroller is operable to generate the third control signal in response to receiving the first and third input signals substantially proximate temporally.

4. The control system of claim 1, wherein the microcontroller is operable to generate the third control signal in response to receiving the third input signal and thereafter the first input signal within a predetermined time period.

5. The control system of claim 1, wherein the microcontroller is operable to generate the third control signal in response to receiving the third input signal and thereafter the first input signal within a programmable time period.

6. The control system of claim 1, wherein the microcontroller is operable to generate the fourth control signal in response to receiving the second and third input signals substantially simultaneously.

7. The control system of claim 1, wherein the microcontroller is operable to generate the fourth control signal in response to receiving the second and third input signals substantially proximate temporally.

8. The control system of claim 1, wherein the microcontroller is operable to generate the fourth control signal in response to receiving the third input signal and thereafter the second input signal within a predetermined time period.

9. The control system of claim 1, wherein the microcontroller is operable to generate the fourth control signal in response to receiving the third input signal and thereafter the second input signal within a programmable time period.

10. The control system of claim 1, further comprising:
at least one pressure sensor operable to sense a water pressure in a conduit proximate to the discharge valve;
at least one flow rate meter operable to sense a flow rate in the conduit proximate to the discharge valve; and
the microcontroller operable to receive the water pressure and flow rate and modulate the motor speed according thereto.

11. A control system for driving a motor that operates a valve, comprising:
an open control switch operable to generate a first input signal in response to manual activation;
a close control switch operable to generate a second input signal in response to manual activation;
a feather control switch operable to generate a third input signal in response to manual activation;
a microcontroller operable to generate a feathered control signal in response to receiving a third signal and one of a first and second input signals substantially simultaneously, the feathered control signal operable to cause the drive motor to change the setting of the discharge valve at a feathered speed.

12. The control system of claim 11, wherein the microcontroller is operable to generate a feathered control signal in response to receiving a third signal and one of a first and second input signals substantially proximate temporally, the feathered control signal operable to cause the drive motor to change the setting of the discharge valve at a feathered speed.

13. The control system of claim 11, wherein the microcontroller is operable in a feather control mode in response to first receiving a third signal and then one of a first and second input signals within a specific time period.

14. A control system for driving a motor that operates a discharge valve, comprising:
a feather control switch operable to generate a feather actuation signal in response to manual activation; and
a microcontroller operable in a feather control mode in response to receiving the feather actuation signal operable to cause the drive motor to change a setting of the discharge valve at a feathered speed.

15. A control method for operating a valve, comprising:
receiving an activation input;
generating a feather signal in response to the activation input;
generating and providing a feather control signal to a motor controlling the valve; and
running the motor to operate the valve at a slower rate of operation.

16. The control method of claim 15, further comprising running the motor to operate the valve at a slower rate of operation only while still receiving the activation input.

17. The control method of claim 15, further comprising running the motor to operate the valve at a slower rate of operation for a predetermined period of time after receiving the activation input.
